(19) United States
(12) Patent Application Publication
(10) Pub. No.: US 2024/0033868 A1
(43) Pub. Date: Feb. 1, 2024

(54) PROCESSING APPARATUS

(71) Applicant: John Bean Technologies Corporation, Chicago, IL (US)

(72) Inventors: Harrison T. Gill, Redmond, WA (US); Gavin David Clements, Sammamish, WA (US); Kaleb Arthur Willis, Everett, WA (US); Alexandru Dopp, Everett, WA (US)

(73) Assignee: John Bean Technologies Corporation, Chicago, IL (US)

(21) Appl. No.: 18/357,015

(22) Filed: Jul. 21, 2023

Related U.S. Application Data
(60) Provisional application No. 63/369,809, filed on Jul. 29, 2022.

(51) Int. Cl. B23Q 5/34; B23Q 7/14; B23Q 11/10

(52) U.S. Cl. CPC B23Q 5/34; B23Q 7/1447; B23Q 11/1007; B23Q 2717/00

(57) ABSTRACT

A system 10 for processing work products 12 includes a housing 14 to contain the components of the system, which include a conveyor 16 for carrying the work products through the housing and past a work tool 18 being supported and moved relative to the conveyor by an X-Y actuator apparatus 20. A scanning system 21 is positioned in the housing 14 upstream of the X-Y actuator for ascertaining selected physical parameters of the work products so as to determine the manner in which the work tool 18 operates on the work products. The housing includes a compartment 22 in which is mounted a high-pressure pump system 23 to provide high pressure working fluid for the work tool 18. Also, a compact guard system 24 is positioned at the outlet 26 of the housing to prevent individuals from reaching into the housing from the exterior.

### CROSS-REFERENCE TO RELATED APPLICATION

This application claims the benefit of U.S. Provisional Application No. 63/369,809, filed Jul. 29, 2022, the entire contents of which are incorporated herein by reference.

### BACKGROUND

Various work tools have been used to carry out operations on workpieces that travel along conveyors. These tools may include, for example, a high speed drilling tool, a water jet cutter, a knife, a laser beam, a welding or brazing tool, a glue dispenser, etc. Commonly the work tool may be supported for movement relative to the workpiece, e.g., transversely and/or longitudinally relative to the direction of movement of the conveyor.

An apparatus for supporting such work tools had previously been developed by applicant. The apparatus is composed of a transverse support structure extending across a conveyor for guiding a wheeled carriage for movement there along. A second longitudinal support structure is cantilevered from the transverse carriage to extend along the length of the conveyor. A second wheeled carriage moves along the longitudinal support structure to carry the working tool. The wheels of both carriages are in the form of rollers that ride on rails mounted the transverse support structure and the longitudinal support structure. The two carriages are powered by remotely located rotational actuators acting through endless belts, with the actuators located to the side of the conveyor.

Although this apparatus was an improvement over previous designs, the apparatus did have shortcomings. For example, to be of sufficient strength and stiffness the longitudinal support structure was required to be constructed of significant weight, thus needing large capacity rotational actuators to move the carriages at high speeds. Such weight lead to wear along the rails and of the rollers, causing the carriages to loosen on the rails, thus affecting the accuracy of the tool movement over the conveyer.

Also, the rails wear more over their center area since that is where the rollers travel the most. Periodically, the roller wheels must be adjusted to remove the slack with the rails. However, the adjustment of the roller wheels had to be made either relative to the more worn center section of the rail or the less worn end sections of the rail. Regardless of the selection made, the roller wheels would not be of proper adjustment for the full length of the rails.

Eventually the rails need to be replaced. This requires a skilled maintenance technician to install the rails so that they are positioned parallel to each other within a couple of thousandths of an inch and also adjust the carriage rollers so that they are correctly preloaded to eliminate excessive clearance between the rollers and the rails, but without overloading the bearings of the rollers. Due to the level of skill and experience needed, these tasks are not always performed properly.

As a further matter, the motive units used to drive the actuator are typically located away from the conveyor, or example off to one side of the conveyor. This has required a drive train of sufficient length to connect the carriages to the motive units. Since the motive units must constantly accelerate, decelerate, reverse direction. accelerate, decelerate, change direction, etc., the larger the mass of the drive train, the larger the required capacity of the motive unit as well as the drive train components.

The disclosure of the present application seeks to address these limitations of existing work tool actuators and their associated processing apparatus.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, an apparatus for supporting and moving a working tool is provided. The apparatus includes: a first longitudinal support structure; a second longitudinal support structure comprising a proximal end portion moveable along the first support structure and a distal end portion cantilevered transversely to the length of the first support structure; a drive system for moving the second support structure along the first support structure; a carriage configured to ride along the second support structure on rollers axled to the carriage, the working tool carried by the carriage; the drive system also moving the carriage along the second support structure; the second support structure defining two laterally [horizontally] spaced apart guide rails extending along the length of the second support structure for engaging the carriage rollers.

In any of the embodiments described herein, wherein the second longitudinal support structure comprising an open web base panel structure having portions defining a longitudinal opening extending along the base panel structure for reception of the carriage.

In any of the embodiments described herein, wherein the guide rails extend along the longitudinal opening extending along the base panel structure.

In any of the embodiments described herein, wherein at least two carriage rollers engage a first of the two guide rails and at least one carriage roller engages the second of the two guide rails.

In any of the embodiments described herein, further comprising a first loading system loading the carriage rollers against respective guide rails.

In any of the embodiments described herein, wherein the first loading system resiliently loads the carriage rollers against respective guide rails.

In any of the embodiments described herein, wherein the first loading system loads the at least one carriage roller against the second guide rail.

In any of the embodiments described herein, wherein the first loading system resiliently loads the at least one carriage roller against the second guide rail.

In any of the embodiments described herein, wherein the base panel structure having side edge portions extending along the base panel structure; and the second longitudinal support structure further comprising side girders extending along and extending upwardly from the side edge portions of the base panel structure.

In any of the embodiments described herein, wherein the side girders comprise an open web structure.

In any of the embodiments described herein, further comprising a top panel structure attached to the side girders at an elevation above the base panel structure.

In any of the embodiments described herein, wherein the top panel structure comprises an open web structure.

In any of the embodiments described herein, wherein the drive system comprises a first motive system for moving the second support structure along the first support structure, the first motive system positioned at an elevation above the first support structure; and a first drive train interconnecting the first motive system with the second support structure to transmit motive force from the first motive system to the second support structure to move the second support structure along the first support structure.

In any of the embodiments described herein, wherein the drive system comprises a second motive system for moving the carriage along the second support structure, the second motive system positioned at an elevation above the first support structure; a second drive train interconnecting the second motive system with the carriage to transmit motive force from the second motive system to the carriage to move the carriage along the second support structure.

In any of the embodiments described herein, further comprising: third and fourth guide rails extending along the first support structure in spaced apart parallel relationship to each other; a first plurality of rollers axled to the proximal end portion of the second support structure and engaged with the third guide rail; a second plurality of rollers axled to the proximal end portion of the second support structure and engaged with the fourth guide rail; a loading system for loading the first plurality of rollers against the third guide rail and for loading the second plurality of rollers against the fourth guide rail.

In any of the embodiments described herein, wherein the first and second plurality of rollers are resiliently loaded against respective first and second guide rails.

In accordance with another embodiment of the present disclosure, a system for processing work products is provided. The system includes: a conveyor for advancing the work products; and an apparatus for supporting a work tool and moving the work tool relative to the conveyor, the apparatus comprising: a first longitudinal support structure; a second longitudinal support structure comprising a proximal end portion moveable along the first support structure and a distal end portion cantilevered transversely to the length of the first support structure; a carriage configured to ride along the second support structure on rollers axled to the carriage, the working tool carried by the carriage; a drive system for moving the second support structure along the first support structure, the drive system also moving the carriage along the second support structure, the drive system comprising a first motive system for moving the second support structure along the first support structure, the first motive system positioned at an elevation above the first support structure, and a second motive system for moving the carriage along the second support structure, the second motive system positioned at an elevation above the first support structure.

In any of the embodiments described herein, wherein the apparatus for supporting a work tool and moving the work tool relative to the conveyor further comprising a first drive train interconnecting the first motive system with the second support structure to transmit motive force from the first motive system to the second support structure to move the second support structure along the first support structure.

In any of the embodiments described herein, wherein the apparatus for supporting a work tool and moving the work tool relative to the conveyor further comprising a second drive train interconnecting the second motive system with the carriage to transmit motive force from the second motive system to the carriage to move the carriage along the second support structure.

In any of the embodiments described herein, wherein the second support structure defines two laterally [horizontally] spaced apart guide rails extending along the length of the second support structure for engaging the carriage rollers.

In any of the embodiments described herein, wherein the second longitudinal support structure comprising an open web constructed base panel structure having portions defining a longitudinal opening extending along the base panel structure for reception of the carriage.

In any of the embodiments described herein, wherein the guide rails extend along the longitudinal opening extending along the base panel structure.

In any of the embodiments described herein, wherein at least two carriage rollers engage a first guide rail of the two laterally spaced apart guide rails and at least one carriage roller engages the second guide rail of the two laterally spaced apart guide rails.

In any of the embodiments described herein, further comprising a first loading system of loading the carriage rollers against respective guide rails.

In any of the embodiments described herein, wherein the first loading system resiliently loads the carriage rollers against respective guide rails.

In any of the embodiments described herein, wherein the first loading system loads the at least one carriage roller against the second guide rail.

In any of the embodiments described herein, wherein the first loading system resiliently loads the at least one carriage roller against the second guide rail.

In any of the embodiments described herein, wherein the base panel structure having side edge portions extending along the base panel structure; and the second longitudinal support structure further comprising side girders extending along and extending upwardly from the side edge portions of the base panel structure.

In any of the embodiments described herein, wherein the side girders comprise an open web structure.

In any of the embodiments described herein, further comprising a top panel structure attached to the side girders at an elevation above the base panel structure.

In any of the embodiments described herein, wherein the top panel structure comprises an open web structure.

In any of the embodiments described herein, further comprising: third and fourth guide rails extending along the first support structure in spaced apart parallel relationship to each other; a first plurality of rollers axled to the proximal end portion of the second support structure and engaged with the third guide rail; a second plurality of rollers axled to the proximal end portion of the second support structure and engaged with the fourth guide rail; a loading system for loading the first plurality of rollers against the third guide rail and for loading the second plurality of rollers against the fourth guide rail.

In any of the embodiments described herein, wherein the first and second plurality of rollers are resiliently loaded against respective third and fourth guide rails.

In any of the embodiments described herein, further comprising: a pump for supplying high pressure fluid for the work tool; a housing for enveloping a portion of the conveyor and the apparatus for supporting the work tool and moving the work tool relative to the conveyor, the housing defining an accessible compartment for locating the pump.

In any of the embodiments described herein, wherein the housing comprises a drawer structure for receiving the pump, the drawing mounted in the housing to be opened for access to the pump and to be closed for separation from the rest of the housing.

In any of the embodiments described herein, wherein the pump is powered by an electrical servo motor.

In any of the embodiments described herein, further comprising a control system, the control system controlling the operation of the pump based on the physical characteristics or parameters of the work product being processed by the work tool.

In any of the embodiments described herein, wherein the control system adjusting the operation of the pump to modulate the pressure of the fluid to the work tool based on the physical characteristics or parameters of the work product.

In any of the embodiments described herein, wherein the control system shifting the pump to a standby status when the work tool is not operating on a work product.

In any of the embodiments described herein, further comprising a scanning system to scan the work products on the conveyor to ascertain physical characteristics or parameters of the work products and generate data related to such physical characteristics or parameters.

In any of the embodiments described herein, wherein the control system adjusting the operation of the pump to modulate the pressure of the fluid to the work tool based on the data from the scanner.

In accordance with another embodiment of the present disclosure an apparatus includes a housing for containing a work tool, the housing defining an accessible compartment separate from the work tool and pump system located in the accessible compartment for supplying high pressure fluid to the work tool.

In any of the embodiments described herein, wherein the housing comprising an inlet opening and an outlet opening through which a conveyor extends for carrying work products to and from the work tool.

In any of the embodiments described herein, wherein the housing comprising a drawer structure for mounting the pump system, the drawing mounted in the housing to be opened for access to the pump system and to be closed for separation from the rest of the housing.

In any of the embodiments described herein, wherein the pump system comprises a pump powered by an electrical servo motor.

In any of the embodiments described herein, further comprising a control system, the control system controlling the operation of the pump based on the physical characteristics or parameters of the work product being processed by the work tool.

In any of the embodiments described herein, wherein the control system adjusts the operation of the pump to modulate the pressure of the fluid to the work tool based on the physical characteristics or parameters of the work product.

In any of the embodiments described herein, wherein the control system shifts the pump to a standby status when the work tool is not operating on a work product.

In any of the embodiments described herein, further comprising a scanning system to scan the work products on the conveyor to ascertain physical characteristics or parameters of the work products and generate data related to such physical characteristics or parameters.

In any of the embodiments described herein, wherein the control system adjusting the operation of the pump to modulate the pressure of the fluid to the work tool based on the data from the scanner.

In any of the embodiments described herein, further comprising: a housing for enveloping a portion of the conveyor and the apparatus for supporting the work tool and moving the work tool relative to the conveyor, the housing comprising an outlet opening through which the conveyor extends for carrying work products from the working tool; and a safety guard assembly at the outlet opening, the safety guard comprising a first curtain of suspended pivoting fingers extending across the conveyor and a second curtain of suspended pivoting fingers extending across the conveyor downstream and adjacent the first curtain of suspended pivoting fingers, the first and second curtains of suspended fingers cooperatively pivoting together in a direction downstream of the direction of travel of the conveyor but preventing the second curtain of suspended fingers from pivoting relative to the first curtain of suspended fingers in the direction downstream of the direction of travel of the conveyor.

In any of the embodiments described herein, wherein the first fingers are suspended from a first pivot axis and define a camming surface relative to the first pivot axis, and the second fingers are suspended from a second pivot axis and define a tab projecting relative to the second pivot axis, the tab abutting the camming surface when the second fingers are sought to be pivoted about the second axis in a downstream direction to prevent such pivoting of the second fingers.

In any of the embodiments described herein, wherein the first and second curtain of suspended figures are prevented from pivoting in an upstream direction by a stop acting on the first and second curtain of suspended fingers.

In any of the embodiments described herein, wherein the stop selected from the group including the conveyor abutting against the lower ends of the first and second curtain of suspended fingers and stop members extending laterally relative to the length of the conveyor to abut against the first and second curtain of suspended fingers.

In any of the embodiments described herein, wherein the safety guard assembly includes a cover structure on which are mounted the first and second curtains of suspended pivoting fingers, the cover pivotally mounted on the housing to pivot the safety guard assembly away from and toward the outlet opening of the housing.

In accordance with another embodiment of the present disclosure, a safety guard assembly is provided for a housing for enveloping a processing apparatus and enveloping a portion of a conveyor for carrying work products to the processing apparatus and from the processing apparatus out through an outlet opening in the housing. The safety guard assembly includes: a barrier curtain having an upper edge portion pivotally suspended about an axis extending across the conveyor adjacent the outlet opening, the barrier curtain having a lower edge portion at or near the conveyor; an abutment system acting on the upper edge portion of the barrier curtain to allow the lower edge portion of the barrier curtain to pivot in a direction downstream of the direction of travel of the conveyor when pushed by the work product being carried on the conveyor to permit the work product to exit the housing and to prevent the lower edge portion of the barrier curtain from be lifted upwardly relative to the conveyor by a lifting force being applied externally of the housing.

In any of the embodiments described herein, wherein the abutment system comprising an abutment barrier curtain positioned upstream of the barrier curtain, the abutment barrier curtain having an upper edge portion suspended about an abutment axis extending across the conveyor, the barrier curtain and the abutment barrier curtain cooperatively pivoting together in a direction downstream of the direction of travel of the conveyor but preventing the barrier curtain from pivoting relative to the abutment barrier curtain in the direction downstream of the direction of travel of the conveyor.

In any of the embodiments described herein, wherein the abutment system comprising a abutment surface at the upper edge portion of the abutment barrier curtain and a tab projecting from the upper edge portion of the barrier curtain, the tab abutting the abutment surface when the barrier curtain is sought to be pivoted about the axis in the downstream travel direction of the conveyor to prevent such pivoting of the barrier curtain.

In any of the embodiments described herein, wherein the barrier curtain comprises a plurality of side-by-side suspended fingers extending across the conveyor.

In any of the embodiments described herein, where in the abutment barrier curtain comprises a plurality of side-by-side suspended fingers extending across the conveyor.

In any of the embodiments described herein, wherein the fingers of the abutment barrier curtain are suspended from the abutment barrier curtain axis and define an abutment surface relative to the abutment barrier curtain axis, and the fingers of the barrier curtain are suspended from the axis of the barrier curtain and define a tab projecting relative to the axis of the barrier curtain, the tab abutting the abutment surface when the fingers of the barrier curtain are sought to be pivoted about the barrier curtain axis in the downstream travel direction of the conveyor to prevent such pivoting of the barrier curtain fingers.

In any of the embodiments described herein, wherein the fingers of the barrier curtain and the fingers of the abutment barrier curtain are prevented from pivoting in an upstream direction of travel of the conveyor by a stop acting on the fingers of the barrier curtain and the fingers of the abutment barrier curtain.

In any of the embodiments described herein, wherein the stop is selected from the group including: the conveyor abutting against the lower ends of the fingers of the barrier curtain and the abutment barrier curtain; and, stop members extending laterally relative to the length of the conveyor to bear against the fingers of the barrier curtain and the abutment barrier curtain.

In accordance with another embodiment of the present disclosure, a system for processing work products, comprising:
a conveyor for advancing the work products;
an apparatus for supporting a work tool and moving the work tool relative to the conveyor, the apparatus comprising:
a first longitudinal support structure;
a second longitudinal support structure comprising a proximal end portion moveable along the first support structure and a distal end portion cantilevered transversely to the length of the first support structure;
a carriage configured to ride along the second support structure on rollers axled to the carriage, the working tool carried by the carriage;
a drive system for moving the second support structure along the first support structure, the drive system also moving the carriage along the second support structure, the drive system comprising a first motive system for moving the second support structure along the first support structure, the first motive system positioned at an elevation above the first support structure, and a second motive system for moving the carriage along the second support structure, the second motive system positioned at an elevation above the first support structure;
a pump system for supplying high pressure fluid for the work tool; and
a control system having circuitry configured to control operation of the pump based on at least one of physical characteristics and parameters of a work product being processed by the work tool.

In any of the embodiments described herein, wherein the control system is configured for adjusting the operation of the pump system to modulate the pressure of the fluid to the work tool based on at least one of the physical characteristics or parameters of the work product.

In any of the embodiments described herein, wherein the control system is configured to shift the pump system to a standby status when the work tool is not operating on a work product.

In any of the embodiments described herein, further comprising a scanning system to scan the work products on the conveyor to ascertain physical characteristics or parameters of the work products and generate data related to such physical characteristics or parameters.

In any of the embodiments described herein, wherein the control system is configured for adjusting the operation of the pump system to modulate the pressure of the fluid to the work tool based on the data from the scanner.

In any of the embodiments described herein, further comprising a housing for enveloping a portion of the conveyor and the apparatus for supporting the work tool and moving the work tool relative to the conveyor, the housing defining an accessible compartment for locating the pump.

In any of the embodiments described herein, wherein the housing comprises a drawer structure for mounting the pump, the drawing mounted in the housing to be opened for access to the pump and to be closed for separation from the rest of the housing.

In any of the embodiments described herein, wherein the pump system comprises a pump powered by an electrical servo motor.

In accordance with another embodiment of the present disclosure, a method for processing work products, comprising:
advancing work products on a conveyor;
moving a work tool relative to the conveyor;
supplying high pressure fluid with a pump to the work tool; and
controlling, with a computing device, operation of the pump based on at least one of physical characteristics and parameters of a work product being processed by the work tool.

In any of the embodiments described herein, further comprising adjusting, with a computing device, a pressure of the fluid supplied to the work tool based on at least one of the physical characteristics or parameters of the work product.

In any of the embodiments described herein, further comprising shifting, with a computing device, the pump to a standby status when the work tool is not operating on a work product.

In any of the embodiments described herein, further comprising:
scanning, with a scanning system the conveyed work products to ascertain physical characteristics or parameters of the work products; and
generating, with a computing device, data related to such physical characteristics or parameters.

In any of the embodiments described herein, further comprising adjusting, with a computing device, the operation of the pump to modulate the pressure of the fluid to the work tool based on the generated data related to such physical characteristics or parameters.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an isometric view of the system for processing work products of the present disclosure taken from above and the front of the system housing;

FIG. 2A is an isometric view similar to FIG. 1, with the pump system tray shown in open position;

FIG. 2B is an isometric view similar to FIG. 2A, but taken from the opposite end of the system housing;

FIG. 3 is a view similar to FIG. 2, with the housing shown in phantom line so that some of the interior components of the processing apparatus are visible;

FIG. 4A is an isometric view of the X-Y actuator of the system of the present disclosure taken from above the actuator;

FIG. 4B is a cross-sectional view of FIG. 4A, taken along lines 4B-4B thereof;

FIG. 5 is an isometric view of a longitudinal support structure of the X-Y actuator taken from beneath;

FIG. 6 is a bottom view of FIG. 5;

FIG. 7 is an isometric view of the longitudinal support structure and of the work tool shown connected to a source of high-pressure fluid, taken from above;

FIG. 8 is an elevational view of the longitudinal support structure taken in the direction of 8-8 in FIG. 7;

FIG. 9A is a partial isometric view of a guard assembly positioned at the outlet end of the housing;

FIG. 9B a cross-sectional view of FIG. 9A, taken along lines 9B-9B thereof;

FIG. 9C is a view of the guard assembly rotated away from the housing;

### DETAILED DESCRIPTION

The description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well known process steps have not been described in detail in order not to unnecessarily obscure various aspects of the present disclosure. Further, it will be appreciated that embodiments of the present disclosure may employ any combination of features described herein.

The present application may include references to “directions,” such as “forward,” “rearward,” “front,” “back,” “ahead,” “behind,” “upward,” “downward,” “above,” “below,” “horizontal,” “vertical,” “top,” “bottom,” “right hand,” “left hand,” “in,” “out,” “extended,” “advanced,” “retracted,” “proximal,” and “distal.” These references and other similar references in the present application are only to assist in helping describe and understand the present disclosure and are not intended to limit the present invention to these directions.

The present application may include modifiers such as the words “generally,” “approximately,” “about,” or “substantially.” These terms are meant to serve as modifiers to indicate that the “dimension,” “shape,” “temperature,” “time,” or other physical parameter in question need not be exact, but may vary as long as the function that is required to be performed can be carried out. For example, in the phrase “generally circular in shape,” the shape need not be exactly circular as long as the required function of the structure in question can be carried out.

In the following description and in the accompanying drawings, corresponding systems, assemblies, apparatus, and units may be identified by the same part number, but with an alpha suffix. The descriptions of the parts/components of such systems assemblies, apparatus, and units that are the same or similar are not repeated so as to avoid redundancy in the present application.

The present disclosure refers interchangeably to “product,” “work product,” “item,” “work item,” “work piece.” Such products may include all manner of foods, as well as non-food products and items.

The present disclosure refers to “air,” which can include only air, but also can include mixtures of air and moisture of varying amounts, including mist or fog.

An apparatus 10 for processing work products 12 includes a housing 14 to contain the components of the system, which include a conveyor 16 for carrying the work products through the upper section 17 of the housing and past a work tool 18 being supported and moved relative to the conveyor by an X-Y actuator apparatus 20. The work products are shown as poultry butterflies, but the present disclosure is not limited to this particular type of food product, or as noted above, even limited to food products.

A scanning system 21 is positioned in the housing compartment 17 upstream of the X-Y actuator for ascertaining selected physical parameters of the work products so as to determine the manner in which the work tool 18 operates on the work products.

The housing includes a lower compartment 22 for a drawer or tray on which is mounted a high-pressure pump system 23 to provide high pressure working fluid for the work tool 18.

Also, a compact guard system 24 is positioned at the outlet 26 of the housing 14 to prevent individuals from reaching into the housing and being injured by the operation of the work tool 18.

In addition, a processor driven control system 28 is provided for controlling the operation of the apparatus 10, including, for example, the conveyor 16, the actuator apparatus 20, the scanning system 21 and the pump system 23. The control system can also prevent or allow access to the interior of the housing 14 by locking or unlocking access doors and drawers.

The X-Y actuator apparatus 20 in basic form includes a first elongate transverse support structure 30, and a second elongate longitudinal support structure 32. The proximal end portion of the longitudinal support structure 32 is mounted on rollers 34 for movement along the transverse support structure 30. The distal end portion of the longitudinal support structure is cantilevered transversely to the length of the transverse support structure.

A carriage 36 is configured to ride along the longitudinal support structure 32 on rollers 38 axled to the carriage, with the working tool 18 carried by the carriage. A drive system 40 moves the longitudinal support structure along the transverse support structure, and also moves the carriage 36 along the longitudinal support structure 32.

To discuss the apparatus 10 in greater detail, the conveyor 16 extends longitudinally through the housing 14. An inlet opening is formed in the housing end wall 50 through which the upstream end of the conveyor 16 extends. Correspondingly, an outlet opening 26 is formed in the opposite housing end wall 52 through which the downstream end of the conveyor 16 extends. The conveyor 16 includes end rollers 54 trained over the end portions of the endless belt 53 of the conveyor, as well as powered for moving the conveyor belt over the supporting bed, in a well-known manner.

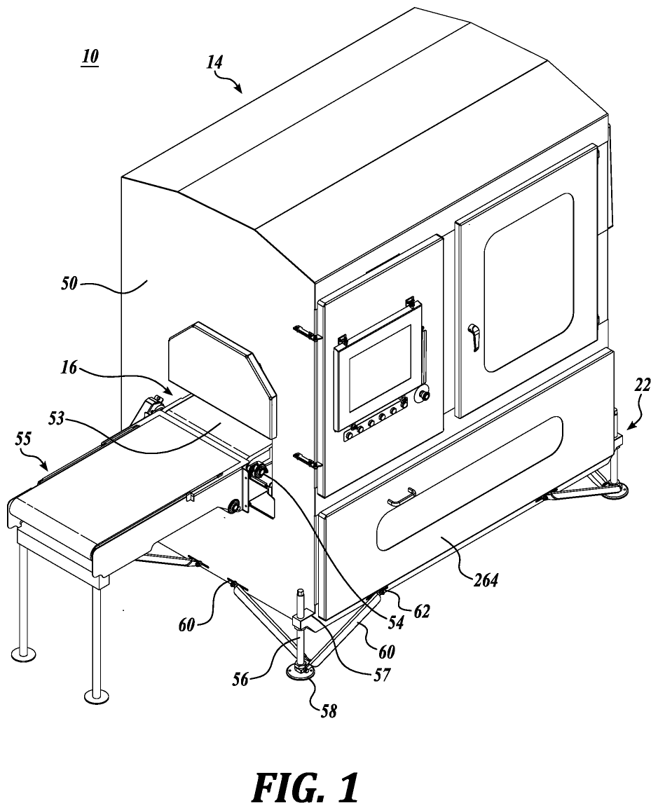

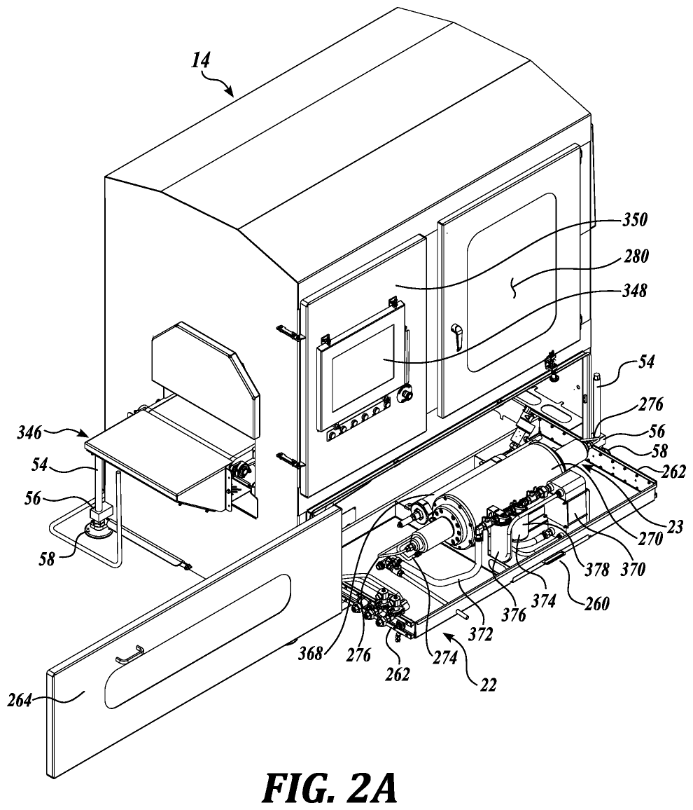

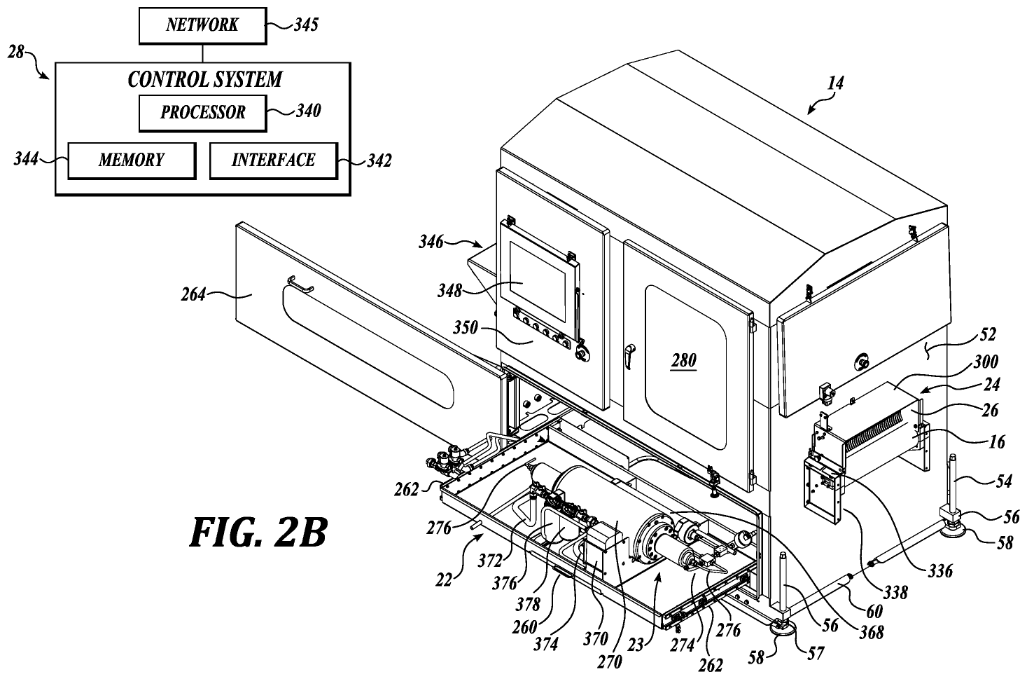

A feed conveyor 55 delivers the work products 12 to the upstream end of the conveyor 16, and a take away conveyor (not shown) transports the processed work products from the downstream end of the conveyor. The feed conveyor 55 and take away conveyor may vary considerably in height from one processing location to another. As such, the housing 14 is adjustable over a significant height to accommodate different installation locations. To this end, jack screws 56 are threaded in vertical openings formed in corner brackets 57 positioned at each corner of the housing. The lower ends of the jackscrews 56 rotatably engage within circular floor pads 58. The upper ends of the jackscrews 56 are configured to receive a socket or other tool that may be used to conveniently rotate the jackscrews to raise and lower the housing 14 as desired, compare FIG. 1 with FIG. 2A.

Braces 60 are provided to add stability between the jackscrews 56 and the housing 14, especially if the housing has been raised upwardly at considerable distance, such as shown in FIG. 1. One end of each brace is pivotally attached to a floor pad 58, and the opposite end of the brace slides within a horizontal slot 62 formed at the base of the housing. In this manner, the angles of the braces can adjust to the height of the housing above the floor. The braces are tightened in the slots 62 once the height of the housing has been adjusted. With the foregoing construction, the housing 14 can be raised and lowered at least 12 inches.

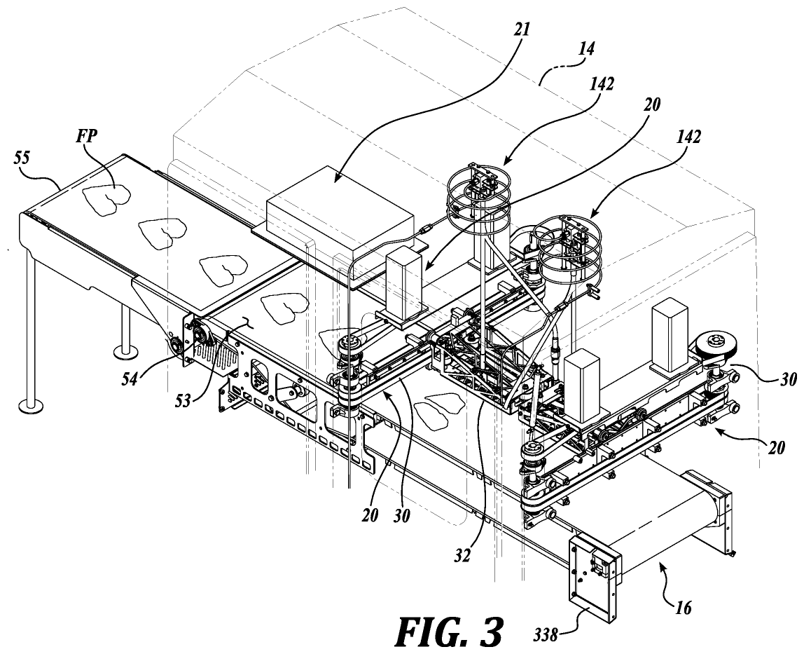

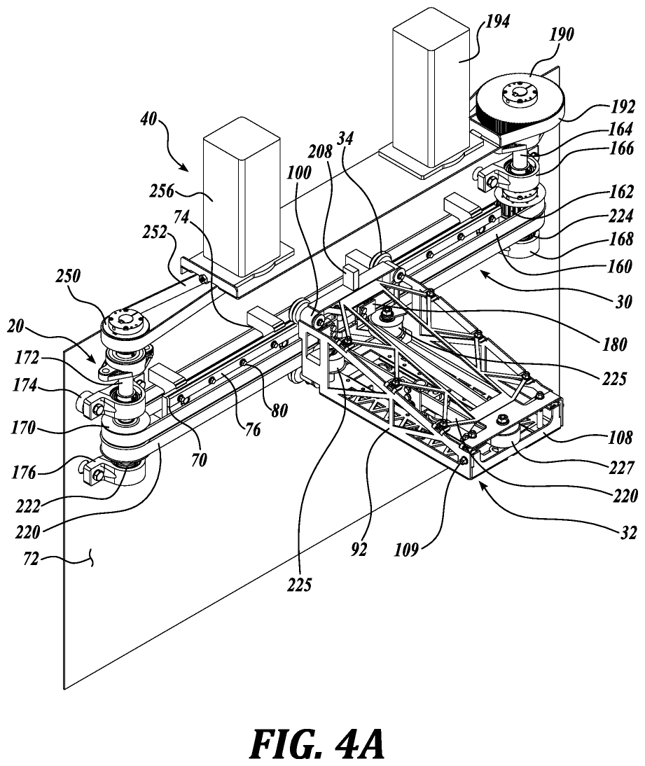

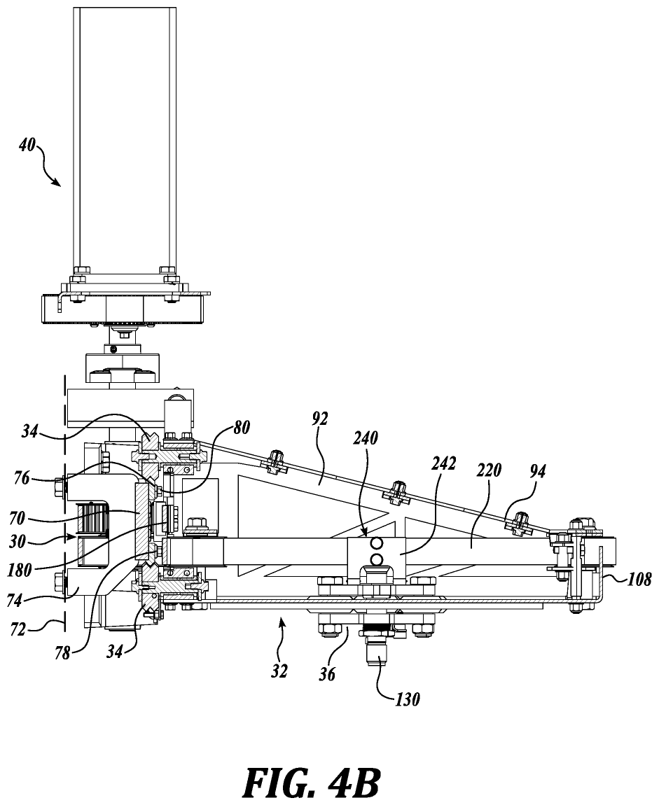

Next, referring specifically to FIGS. 3, 4A, and 4B, the transverse support structure 30 is composed of an elongate flat bar 70 extending horizontally across the conveyor 16. The bar is mounted to a housing wall 72 by u-shaped brackets 74 extending outwardly from the wall 72. The bar 70 is attached to the vertical legs of the brackets 74.

Upper and lower rails or tracks 76 and 78 for guiding the longitudinal support structure 32 are mounted to the upper and lower margins of the bar 70 to extend along the length of the bar. Hardware members 80 extend through openings formed in the rails/tracks to engage threaded holes formed in the bar 70. The openings in the rails/tracks can be slotted so as to provide adjustability of the rails/tracks relative to each other. The upper edge of the upper rail 76 and the lower edge of the lower rail 78 are crowned to engage the concave outer perimeters of the rollers 34. As such, the proximal end of the longitudinal support structure 32 is held captive on the rails 76 and 78 while traveling back and forth along the transverse support structure 30.

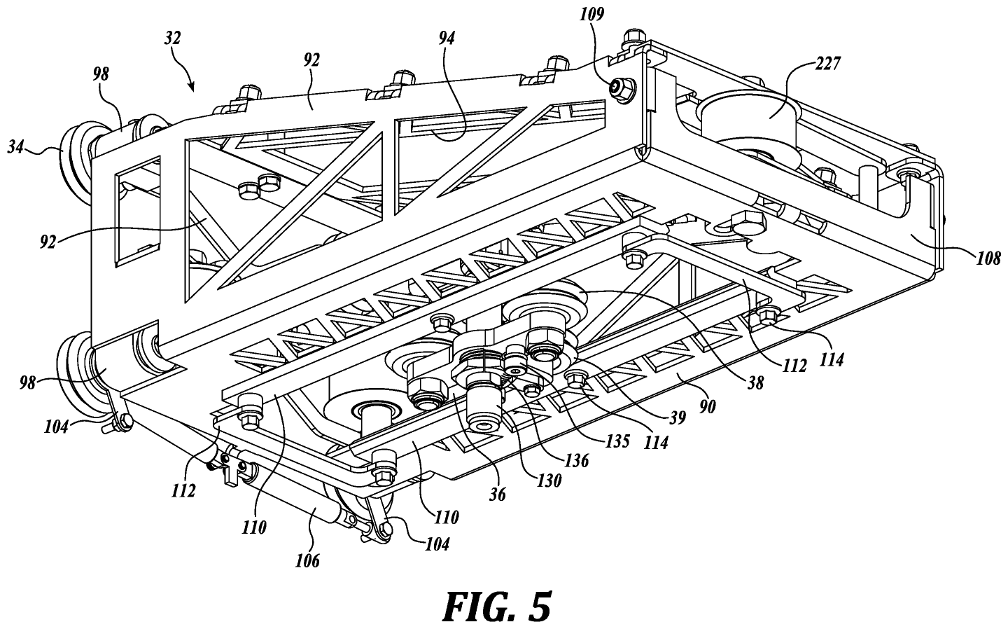

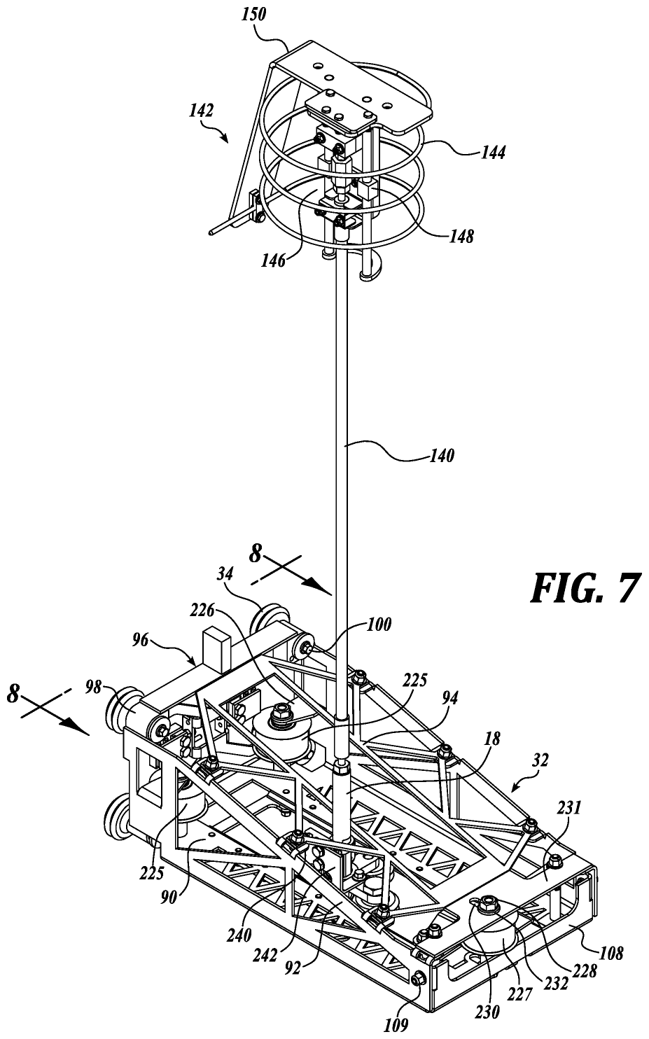

Next, also referring to FIGS. 5-8, as noted above the longitudinal support structure 32 moves along the support structure 30 while cantilevering transversely therefrom. The longitudinal support structure is generally in the form of an open web box beam. In this regard, the longitudinal support structure 32 includes an open web base panel structure 90, open web side girders 92, and an open web top panel structure 94.

At its proximal end adjacent the transverse support structure 30, the box beam includes a generally cross-shaped end structure 96 attached to the adjacent ends of the base panel structure 90, girders 92, and top panel structure 94 so as to tie together these structural components of the box beam.

Axle housings 98 for the rollers 34 are mounted to the distal ends of the four arms 99 that compose the structure 96. The axle housings 98 received the ends of upper axles 100 and the lower axles 101 used to mount rollers 34 to the box beam of the longitudinal support structure 32.

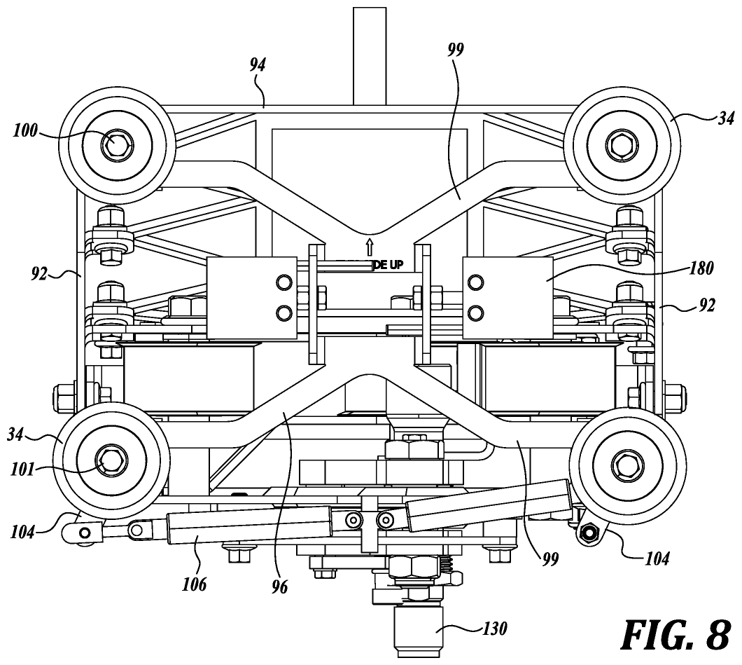

The axles 101 of the lower rollers 34 are of offset or eccentric construction. Transverse tie arms 104 extend from these axles for attachment to the adjacent ends of resilient linear actuators in the form of gas springs 106. The opposite ends of the gas springs are pivotally anchored to the end structure 96 of the transfer support structure 32. The gas springs 106 apply a load to the eccentric axles 101 tending to increase the vertical distance separating the rollers 34 on each side of the end structure 96 shown in FIG. 8. This has the effect of applying a preload on the rollers 34 against their respective upper and lower rails 76 and 78. As such, the rollers 34 remain engaged against the upper and lower rails 76 and 78 even as the rails 76 and 78 and/or rollers 34 wear. Accordingly, the accuracy of the location of the work tool relative to the conveyor is maintained.

The loading of the rollers 34 can be accomplished by other means rather than through the use of the gas springs 106. For example, such gas springs could be replaced by extension springs or an elastic band.

As noted above, the box beam construction of the longitudinal support structure 32 includes a base panel structure 90. Such base panel structure 90 forms the bottom of the box beam. In this regard, the base panel structure 90 includes a longitudinal, generally rectangular central opening extending substantially along the length of the base panel structure. The portions of the base panel structure along the sides of the central opening are of open web construction providing sufficient structural strength for the base panel structure, while reducing its weight.

Girders 92 extend upwardly from the sides' edges of the base panel structure 90. As noted above, the girders are of open web construction. In this regard, inside profile, the girders include a horizontal lower cord and an upper cord that is sloped downwardly from the proximal end of the longitudinal support structure 32, thereby reducing the weight of the girders, while being of sufficient strength to easily carry the load required of the longitudinal support structure 32. Girders 92 can be constructed integrally with the base panel structure 90, or they can be of separate construction and attached to the base panel structure.

A top panel structure 94 of open web construction extends across the top portion up the box beam, interconnecting the upper margins of the girders 92. The top panel structure 94 defines an elongate central opening corresponding to the opening formed in the base panel structure 90, discussed above. This opening provides clearance for the work tool 18 that moves with the 36 carriage along the length of the longitudinal support structure 32.

A u-shaped end panel 108 is positioned at the distal end of the box beam. The end panel 108 is illustrated as being integrally constructed with the base panel structure 90, but can be of separate construction. The end panel 108 is attached to the distal ends of the girders, for example, by use of hardware members 109. However, they end panel 108 can be otherwise attached to the girders, such as by welding. As can be appreciated, the end panel 108 adds structural strength and rigidity to the box beam structure.

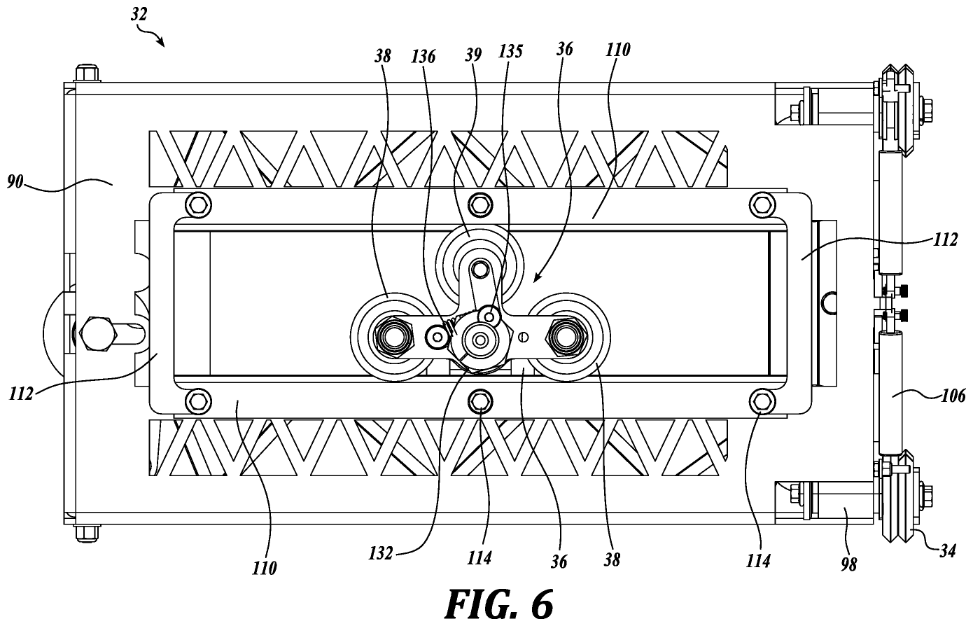

Referring to FIGS. 5 and 6, elongate side rails 110 are mounted horizontally to the base panel structure 90 to extend along the sides of the central opening and extend into the central opening a distance to provide clearance of the rollers 38 of carriage 36. End ties 112 span between and connect the end of the side rails 110 together. The elongate side rails 110 and end ties 112 are attached to the base panel structure 90 by appropriate hardware members 114.

The carriage 36 may be generally in the shape of a truncated “T.” Rollers 38 are mounted to the ends of the flange portion of the carriage, and a single roller 39 is mounted at the end of the truncated web portion of the carriage. The figures show that the work tool 18 in the form of a water jet nozzle 130 is mounted at the intersection of the flange and web portions of the carriage with a mounting assembly 132. However, as noted herein, other tools 18 may be carried by the carriage.

The two rollers 38 ride along one of the rails 110, and the singular roller 39 rides along the opposing rail 110. In this regard, the edge portions of the rails 110 that engage the rollers 38 and 39 are crowned or otherwise shaped to closely receive and engage rollers, which are shaped in a corresponding manner. In this regard, the rollers 38 and 39 are held captive between the rails 110.

The roller 39 is mounted on an eccentric axle. A tie arm 135 is fixed to the axle to extend transversely relative to the axle. An extension spring 136 is attached to the distal end of the tie arm 135, with the opposite end of the spring attached to the flange portion of the carriage 36. As a result, the roller 39 is loaded against its corresponding rail 110, which in turn also loads the rollers 38 against the opposing rail 110. As a consequence, the carriage rollers 38 and 39 remain in constant contact with the rails 110 and are substantially uniformly loaded against the rails even as the rails and/or rollers 38 and 39 exhibit wear. As a result, the need to manually adjust the loading of the rollers 38 and 39 against the rails 110 is eliminated.

As noted above, one form of the work tool 18 may be in the form of a high pressure water jet nozzle 130 which is mounted on the carriage 36 for movement with the carriage along the length of the conveyor 16, as well as for movement with the longitudinal support structure 32 along the length of the transverse support structure 30 (across the conveyor 16).

High pressure fluid, e.g., water, may be supplied to the nozzle 130 by a supply line or hose 140 extending downwardly from an overhead fluid delivery/connector system 142. The system 142 in basic form includes a high pressure tubular coil 144 connected to the upper end of the flexible hose 140 by an interface connector assembly 146 that is movable up and down to accommodate the movement of the lower end of the flexible hose which is connected to the nozzle assembly 130. The interface connector assembly 146 is carried by a guide in the form of a guideway 148 to travel up-and-down between a nominal upward position, as shown, and a lowered position as the carriage move away from being directly underneath the interface connector assembly 146. The guideway 148 is mounted on a mounting bracket assembly 150 that can be mounted in a stationary location within the housing 14. The fluid delivery/connector system is the subject matter of U.S. patent Ser. No. 11/118,704, incorporated herein by reference.

Next describing the drive system 40 in more detail, in one aspect the drive system powers the longitudinal support structure 32 to move back and forth along the transverse support structure 30. In this regard, as shown in FIG. 4A, a timing belt 160 is engaged with a drive pulley 162 fixed to a vertical drive shaft 164, which is mounted on housing wall 72 by upper and lower pillow blocks 166 and 168. The timing belt 160 also wraps around an idler pulley 170 rotationally mounted on a drive shaft 172 located across the conveyor belt from the drive shaft 164. The drive shaft 172 is also mounted on housing wall 72 by upper and lower pillow blocks 174 and 176.

The timing belt 160 is attached to the proximal end structure 96 of the longitudinal support structure 32 by two sets of clamping plate assemblies 180 having first and second face plates that are clapped against the opposite sides of the timing belt 160. See also, FIG. 8. In this manner, the longitudinal support structure moves with the movement of the timing belt 160.

A driven pulley 190 is fixed to the upper end of drive shaft 164. A drive belt 192 connects the driven pulley 190 to a drive pulley, not visible, disposed beneath a servo motor 194 located laterally of the driven pulley toward the longitudinal center of the conveyor belt 53. In this manner, the servo motor 194 is located in close proximity to the driven pulley 190 as well as to the drive shaft 164, thereby minimizing the extent of the drive train needed to power the timing belt 160.

Housing 14 includes a panel, not shown, that divides the servo motor 194, drive pulley and driven pulley 190 from the transverse support structure 30 and longitudinal support structure 32 to help maintain the cleanliness of the operation of the work tool 18.

By the foregoing construction, the system 40 is capable of quickly accelerating and decelerating the longitudinal support structure 32 for movement along the transverse support structure. This capability is enhanced by limiting the mass of the drive system 40 and the longitudinal support structure-described above.

The drive system 40 is also utilized to move the carriage 36 back and forth along the length of the longitudinal support structure 32. To this end, an endless timing belt 220 is engaged with a drive pulley 222 fixed to a lower portion vertical drive shaft 172, which as noted above is mounted on housing wall 72 by upper and lower pillow blocks 174 and 176. The timing belt 160 also wraps around an idler pulley 224 that is rotationally mounted to the lower portion of drive shaft 164. As noted above, the drive shaft 164 is mounted on housing wall 72 by upper and lower pillow blocks 166 and 168.

The endless belt 220 also trains around idler pulleys 225 mounted to the proximal end portion of the longitudinal support structure. The idler pulleys 225 are mounted on vertical shafts that are fixed to brackets 226 that extend inwardly for the girders 92. The idler pulleys 225 serve to redirect the belt to extend along the length of the longitudinal support structure 32 outward of the tool to wrap around an end idler pully 227 mounted at the distal end of the longitudinal support structure. The idler end pully 227 rotates on a vertical shaft 228 that extends through upper and lower slots 230 formed in an upper cross plate 231 spanning between the girders 92. The cross plate 231 can be formed as part of the base panel structure 90, or can be independently formed. The ends of the shaft 228 are fixed in place along the slots 230 by hardware members 232. In this manner, the desired tension on the belt 220 can be set.

The belt 220 is attached to the carriage by a clamping bracket assembly 240. The assembly includes an angle bracket 242 extending laterally and then upward from the carriage 36 to be disposed along the outside surface of the belt 220. The clamping bracket assembly also includes a clamping plate, not visible, of the opposite side of the belt to the bracket 242 to capture the belt 220 therebetween. The clamping plate that is contoured along one face to match the shape and sizes of the ribs on the interior side of the belt. In this manner, the belt is securely captured when the clamping plate 244 is bolted or otherwise affixed to the bracket 242.

A driven pulley 250 is fixed to the upper end of drive shaft 172. A drive belt 252 connects the driven pulley 250 to a drive pulley (not visible) disposed beneath a servo motor 256 located laterally of the driven pulley 250 toward the longitudinal center of the conveyor belt 53 and toward the servo motor 194. In this manner, the servo motor 256 is located in close proximity to the driven pulley 250 as well as to the drive shaft 172, thereby minimizing the extent of and the complexity of the drive train needed to power the timing belt 220 and the carriage 36 while being able to quickly accelerate and decelerate the carriage for movement along the longitudinal support structure 32. Moreover, construction of the drive system 40 helps minimizes the footprint occupied by the system 10.

As shown in FIG. 3, two sets of actuator apparatus 20 are shown as mounted facing each other within the housing 14. This results in a very compact configuration of the apparatus 10. As a non-limiting example, the overall length of the housing can be as short as about 42 inches. This enables the system 10 to be installed into many locations that are too small for existing processing systems to utilized.

Nonetheless, it is possible to employ additional sets of actuator apparatus 20, for example, to process two rows of work products on the conveyor 16. In this regard, the housing 14 can be lengthened accordingly.

Next referring to FIGS. 2A and 2B, pump system 23 is mounted in pull out drawer or tray 260 positioned in a lower compartment 22 of the housing 14. The drawer/tray 260 is in turn mounted in the compartment using telescoping slides 262 located along the sides of the tray. A door 264 is hinged to the housing 14 to provide access to the tray 260 and pump system 23.

The pump system 23 includes high pressure fluid pump 270 mounted generally centrally on the drawer/tray. In one example of the present disclosure, the pump 270 may be in the form of a servo pump. The servo pump includes a plunger that is driven back and forth along its length in a sealed chamber to pressurize the fluid fed to the pump. The plunger is driven by a rotatable ball screw located nominally generally centrally along the length of the plunger. The ball screw is reciprocally rotated by an electrical servo motor.

As shown in FIGS. 2A and 2B a low-pressure fluid inlet line 274 is connected to each end of the pump 270. Also, a high-pressure fluid outlet line 276 is connected to each end of the pump 270 that leads to the work tool 18 that is shown to be in the form of a high-pressure nozzle 130. A quick disconnect connector is used to attach the inlet lines 274 to an external water source. Also, a quick disconnect connector may be used between the outlet lines and the high-pressure line leading to the work tool. These quick disconnect connectors enable the pump system 23 to be quickly and conveniently removed from the housing 14.

In this regard, the drawer/tray 260 can simply be removed from the housing and if desired, replaced with another drawer/tray with a replacement pump system 23. It will be appreciated that other lines, such as data lines or electrical lines, leading to the pump system 23 may also employ quick disconnect connectors to conveniently connect and disconnect such lines.

An attenuator 368 is located behind the pump. The attenuator receives the high-pressure fluid from the pump 270, and then passes the high pressure fluid to the work tool without pressure spikes that may be generated by the pump.

An oil cooling system is used to cool the ball screw of the servo motor. In this regard, a heat exchanger 370 cools the oil. Hot oil from the ball screw is routed to the heat exchanger through line 372 and the cooled oil is routed back to the ball screw through line 374.

Also, oil filters 376 and 378 are used to remove particulate and water or moister from the cooling oil. The oil filters are located in front of the pump because the filters need regular service. So, locating the filers in this location facilitates access to the filters.

On the other hand, the attenuator 368 seldom needs services or maintenance. As such the attenuator is located behind pump 270. Other components of the pump system 23 are located at least in part based on accessibility, which in turn is based on typical frequency of maintenance or service.

The pump 270 has numerous advantages over pumps that are directly driven by the use of a crankshaft or pumps that use intensifiers driven by hydraulic cylinders to increase the pressure of the fluid. One such advantage is that the servo motor pump is significantly smaller in overall size relative to a direct drive or intensifier pump of the same capacity. The smaller size of the servo motor pump allows it to be mounted in the lower compartment 22 on sliding tray 260. Direct drive and intensifier pumps are too large to located in the lower compartment 22.

By locating the servo pump 270 in the lower compartment 22, the pump is close to the work tool 18. As such the time required for a pressure change in the fluid caused by the pump to reach the work tool 18 is minimized. Such lag time is much longer if the pump needs to be located away from the apparatus 10, for example at a central pumping station of the facility at which the apparatus 10 is installed.

Moreover, the servo pump can modulate the pressure of the fluid much faster than can a direct drive pump or an intensifier pump. As such, with a servo pump it is possible to alter the pressure of the fluid to the work tool based on changes in the physical parameters of the work product. For example, if the work product is relatively thick, the fluid pressure can be increased, whereas if the work product is thinner, the fluid pressure can be reduced.

The thickness of food product, such as chicken pieces or fish, can vary greatly from piece to piece or even within a single piece. A scanner can be used to analyze the work product as it approaches the work tool, and the control system can send control signals to the servo pump to vary the output pressure of the pump. The servo motor is able to change the speed of the pump fast enough to make this manner of operating a reality. This is not possible with a direct drive or intensifier pump.

In addition, when the work tool is not operating on a work product, even for a small fraction of a second, the control system can switch the servo pump to a standby mode so as not to pump fluid, but at the same time maintaining a desired pressure level of the fluid. As a result, less energy is needed to operate the system 10.

As can be appreciated, mounting the pump system 23 in the forgoing manner eliminates the need for the typical pump room required at processing facilities where pumps and motors are used for supplying high pressure fluid to the water jet nozzles or other work tools. It will also be appreciated that by the present construction, the pump system 23 is readily accessible for service and repair from the front side of the housing.

Although the pump system 23 has been shown in described in conjunction with housing 14 and tray 260 and work tool 18, it will be appreciated that the pump system 23 or similar pump system can be used in conjunction with other housings or other tray or drawer systems or other work tools wherein the pump system is located at or near the work tool so that high pressure fluid does not need to routed to the work tool from a central location in the facility where the work tool is located.

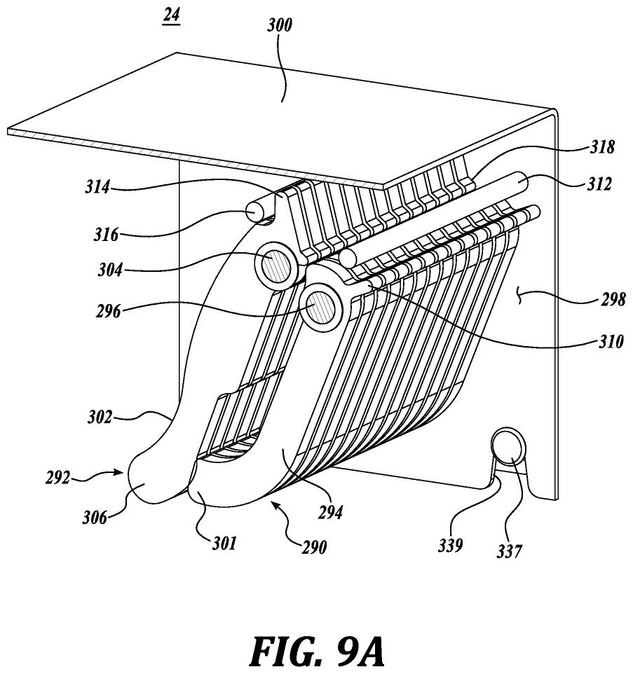

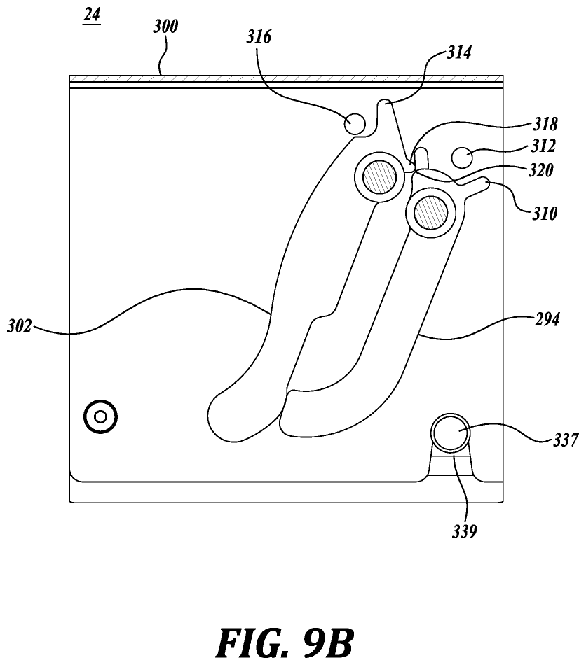

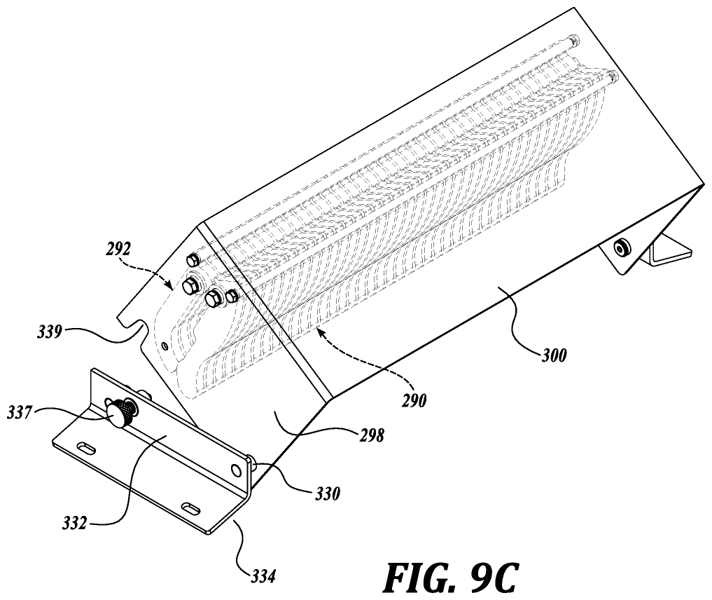

As shown in FIGS. 2B, 9A, 9B, and 9C, the guard system 24 prevents access to the interior of the housing 14 through the outlet 26 located in the housing end wall 52. It is expected that access to the interior of the housing 14, especially to the work tools 18, is via front door 280, which is disabled from opening while the system 10 is in operation. Also, unless a security code is employed, the system 10, including the work tools 18, will not operate if the door 280 is not securely closed.

The guard system 24 includes an upstream finger curtain 290 and an adjacently located downstream finger curtain 292. The upstream finger curtain 290 is composed of a plurality of individual, sculpted elongate fingers 294 having flat sides. The fingers 294 are disposed side-by-side to each other across the conveyor 16. The fingers 294 are suspended by their upper end portions on a cross pivot rod 296 that spans between the vertical side panels 298 of a cover structure 300, which in part mounts the guard system 24 to the housing end wall 52. The lower ends 301 of the fingers 294 rest lightly on the conveyor belt 53 and the fingers slope from the cross rod 296 toward the downstream direction of the conveyor. In this regard, the lower ends 301 of the fingers 294 are curved in the downstream direction of the conveyor.

The downstream finger curtain 292 is correspondingly composed of a plurality of individual, sculpted elongate fingers 302 having flat sides. The fingers 302 are disposed side-by-side to each other across the conveyor 16. The fingers 302 are also suspended by their upper end portions from across pivot rod 304 that spans between the vertical side panels 298 of the cover structure 300. The lower ends 306 of the fingers 302 rest lightly on the conveyor belt 53, and the fingers slope from the pivot rod in the downstream direction of the conveyor. In this regard, the lower ends 306 of the fingers 302 are curved in the downstream direction of the conveyor. To reduce their weight, a generally rectangular shaped opening is formed along the length of the fingers 302.

It can be appreciated that the curvatures of the lower ends 301 of the fingers 294 and 306 of the fingers 302 prevent the fingers from being pushed in the direction upstream relative to the conveyor. In this regard, the lower ends 301 and 306 of the fingers 294 and 302 bottom against the top surface of the conveyor belt 53 to prevent the pivoting of the fingers about their pivot rods 296 and 304.

Further, even if for some reason the lower ends 301 and 306 of the fingers do not bottom on the conveyor belt surface, the fingers are nonetheless prevented from being pushed in the direction into to the housing. As shown in FIGS. 9A and 9B, if the fingers 294 are pushed in the direction into the housing, a stop tab 310 projecting radially from the upper end portion of the fingers 294 abuts against a stop cross rod 312 to prevent further rotation of the finger. Likewise, if the fingers 302 are pushed in the direction into the housing, a stop tab 314 projecting radially from the upper end portion of the finger 302 abuts against a stop cross rod 316 to prevent further rotation of the finger. The stop cross rods span between the side panels of the cover 300.

The fingers 294 and 302 are designed to cooperatively simultaneously pivot in the downstream direction, for example, to ride over the top surface of a processed work product 12 that is exiting the housing. But it is not possible to seek to gain access to the housing 14 by lifting the lower ends 301 and 306 of the fingers. To gain access to the upstream fingers 294, it would first be necessary to lift the downstream fingers 302. However, if an attempt is made to do so, a second stop tab 318 projecting from the upper end of the finger 302 abuts against the adjacent surface 320 of upper end of finger 294, thereby preventing rotation of the fingers 302 in the downstream direction.

In the foregoing manner, the fingers 302 function as a barrier curtain 292, and the fingers 294 function as an abutment barrier curtain 290. The barrier curtain 292 and the abutment barrier curtain 290 cooperatively pivoting together in a direction downstream of the direction of travel of the conveyor, but preventing the barrier curtain 292 from pivoting relative to the abutment barrier curtain 290 in the direction downstream of the direction of travel of the conveyor 16. As noted above, this is due to the second stop tab 318 projecting from the upper end of the fingers 302 of the barrier curtain 292 abutting against the adjacent surface 320 of upper ends of fingers 294 of the abutment barrier curtain 290, thereby preventing rotation of the fingers 302 of the barrier curtain 302 in the downstream direction.

In the typical situation, a housing of the type of housing 14 is required to extend a substantial distance downstream from the work tools 18 so that it is not possible to reach into housing from the outlet side to be injured by the work tool. In other situations, a tunnel extends downstream of the end of the housing and over the conveyor to prevent one from reaching reach into housing from the outlet side to be injured by the work tool.

It will be appreciated that the guard system 24 prevents access to the interior of the housing while occupying very little distance downstream from the housing end wall 52, thereby contributing to the compactness of the system 10.

Also, the entire guard system 24 can be rotated away from the housing end wall 52 by pivoting about pivot pins 330 projecting from the upright legs 332 of angle brackets 334 and extend through clearance holes formed in the lower corners of the side panels 298 of cover 300. The angle brackets 334 are mounted to the upper flanges 336 of shallow box brackets 338, which are in turn fastened to the housing end wall 52.

FIG. 9C shows the guard system 24 partially rotated away from the housing side wall 52. Upwardly extending slots 339 are formed in the lower edge portions of the cover side panels 298 for receiving stop pins 337 that project from the upright legs 332 of the angle brackets 334. The slots 339 are lifted upward away from stop pins 337 when the guard system 24 is rotated in the directions away from the housing end wall 52. In this manner, the entire guard system can be moved out of the away to gain access to the adjacent area of the housing interior and the conveyor 16 for cleaning and other purposes.

Although the fingers 294 and 302 are shown as being relatively narrow in width, the fingers can be a wider or narrower that as shown in FIGS. 9A-9C. Further, the fingers 294 and 302 could be replace by formed plates that span across the conveyor 16 and that include stop tabs similar to stop tabs 310 and 314. The formed plates can also include a second stop tab similar to second stop tab 318 projecting from the upper end the formed plate corresponding to fingers 302 to abut against an adjacent surface similar to the surface 320 of upper end of finger 294.

Although the guard system 24 has been shown in described in conjunction with housing 14 and work tool 18, it will be appreciated that the guard system 24 or similar guard system can be used in conjunction with other housings and/or other work tools and provide the benefits of the guard system 24.

As noted above, the workpieces 12 are inspected by the scanning system 21 to ascertain physical parameters/characteristics of the workpieces pertaining to, for example, the size and/or shape of the workpieces. Such parameters/characteristics may include, for example, the length, width, length/width aspect ratio, thickness, thickness profile, contour, outer contour configuration, flatness, outer perimeter configuration, outer perimeter size and shape, volume and/or weight, as well as whether the workpieces contain any undesirable materials, such as bones, fat, cartilage, metal, glass, plastic, etc., as well as the location of such undesirable materials in the workpieces. The data from the scanning operation is transmitted to the control system 28.

The scanning system 21 may be a variety of different types, including a video camera (not shown) to view a workpiece 12 illuminated by one or more light sources. Light from the light source is extended across the moving conveyor belt 53 to define a sharp shadow or light stripe line, with the area forwardly of the transverse beam being dark. When no workpiece 12 is being carried by the conveyor 16, the shadow line/light stripe forms a straight line across the conveyor belt 53. However, when a workpiece 12 passes across the shadow line/light stripe, the upper, irregular surface of the workpiece produces an irregular shadow line/light stripe as viewed by a video camera (not shown) directed diagonally downwardly on the workpiece and the shadow line/light stripe. The video camera detects the displacement of the shadow line/light stripe from the position it would occupy if no workpiece were present on the conveyor belt. This displacement represents the thickness of the workpiece along the shadow line/light stripe.

The length of the workpiece is determined by the distance of the belt travel that shadow line/light stripes are created by the workpiece. In this regard, the encoder, integrated into the conveyor 16, generates pulses at fixed distance intervals corresponding to the forward movement of the conveyor.

In lieu of a video camera, the scanning station may instead utilize an X-ray apparatus for determining the physical characteristics of the workpiece, including its shape, mass, and weight. X-rays may be passed through the object in the direction of an X-ray detector (not shown). Such X-rays are attenuated by the workpiece in proportion to the mass thereof. The X-ray detector is capable of measuring the intensity of the X-rays received thereby, after passing through the workpiece. This information is utilized to determine physical parameters pertaining to the size and/or shape of the workpiece, including, for example, the length, width, aspect ratio, thickness, thickness profile, contour, outer contour configuration, perimeter, outer perimeter configuration, outer perimeter size and/or shape, volume and/or weight, as well as other aspects of the physical parameters/characteristics of the workpiece. With respect to the outer perimeter configuration of the workpiece 12, the X-ray detector system can determine locations along the outer perimeter of the workpiece based on an X-Y coordinate system or other coordinate system. An example of such an X-ray scanning device is disclosed in U.S. Pat. No. 5,585,603, incorporated by reference herein.

The foregoing scanning systems are known in the art and, thus, are not novel per se. However, the use of these scanning systems in conjunction with the other aspects of the described embodiments of the present disclosure is believed to be new.

The control system 28 includes a processor or computer 340 and an interface 342 therefor for receiving signals and information from the scanning system 21, as well as other data sources of system 10 that may be utilized. A memory unit 344 is provided for storing digital information regarding the control system 28. In addition to and/or in lieu of a local memory unit, the memory for the control system can be remotely located, for example, as part of a local or wide area network 345 or in the cloud. Transmission of data between the memory and the control system 28 can be by wired connection or by wireless connection.

An input/output device in the form of an HMI 346 is provided to enable an operator to communicate with the control system 28. The HMI 346 includes touch screen 348 that is mounted to a forward panel 350 of the housing to convey information to and from the processing system, including the operational parameters of the processing apparatus 10 as well as the functioning of the apparatus, including performance of the apparatus. For example, the results of analyzing the actual cutting path taken by the cutting nozzle 130 when portioning and/or trimming the workpiece 12. The control system 28 includes circuitry that functions to control the operation of the apparatus 10, including for example, the conveyor 16, scanning system 21, the pump system 270 and the work tool 18. The control system 28 can be connected to the network 345. Also, rather than employing an on-board control system 28, a local or remote network computing system can be used for this purpose.

While illustrative embodiments have been illustrated and described, it will be appreciated that various changes can be made therein without departing from the spirit and scope of the invention. For example, the work tool 18 can be mounted on the carriage to move up and down in the Z direction, i.e., in the direction normal to the conveyor belt 53. In this regard, a vertically moveable mounting assembly can be carried by the carriage 36. Such mounting assembly can be in the form of a linear or other type of actuator. Alternatively, the mounting assembly can be composed of telescoping sections the extend and retract relative to each other to move the work tool 18 in the Z direction.

While illustrative embodiments have been illustrated and described, it will be appreciated that various changes can be made therein without departing from the spirit and scope of the invention.

1. An apparatus for supporting and moving a working tool, comprising:
a first longitudinal support structure;
a second longitudinal support structure comprising a proximal end portion moveable along the first support structure and a distal end portion cantilevered transversely to the length of the first support structure;
a drive system for moving the second support structure along the first support structure;
a carriage configured to ride along the second support structure on rollers axled to the carriage, the working tool carried by the carriage;
the drive system also moving the carriage along the second support structure;
the second support structure defining two laterally spaced apart guide rails extending along the length of the second support structure for engaging the carriage rollers.

2. The apparatus of claim 1, wherein the second longitudinal support structure comprising an open web base panel structure having portions defining a longitudinal opening extending along the base panel structure for reception of the carriage.

3. The apparatus of claim 2, wherein the guide rails extend along the longitudinal opening extending along the base panel structure.

4. The apparatus of claim 3, wherein at least two carriage rollers engage a first of the two guide rails and at least one carriage roller engages the second of the two guide rails.

5. The apparatus of claim 4, further comprising a first loading system loading the carriage rollers against respective guide rails.

6-8. (canceled)

9. The apparatus of claim 2, wherein:
the base panel structure having side edge portions extending along the base panel structure; and
the second longitudinal support structure further comprising side girders extending along and extending upwardly from the side edge portions of the base panel structure.

10-14. (canceled)

15. The apparatus of claim 1, further comprising:
third and fourth guide rails extending along the first support structure in spaced apart parallel relationship to each other;
a first plurality of rollers axled to the proximal end portion of the second support structure and engaged with the third guide rail;
a second plurality of rollers axled to the proximal end portion of the second support structure and engaged with the fourth guide rail;
a loading system for loading the first plurality of rollers against the third guide rail and for loading the second plurality of rollers against the fourth guide rail.

16. (canceled)

17. A system for processing work products, comprising:
a conveyor for advancing the work products; and
an apparatus for supporting a work tool and moving the work tool relative to the conveyor, the apparatus comprising:
a first longitudinal support structure;
a second longitudinal support structure comprising a proximal end portion moveable along the first support structure and a distal end portion cantilevered transversely to the length of the first support structure;
a carriage configured to ride along the second support structure on rollers axled to the carriage, the working tool carried by the carriage;
a drive system for moving the second support structure along the first support structure, the drive system also moving the carriage along the second support structure, the drive system comprising a first motive system for moving the second support structure along the first support structure, the first motive system positioned at an elevation above the first support structure, and a second motive system for moving the carriage along the second support structure, the second motive system positioned at an elevation above the first support structure.

18-19. (canceled)

20. The system of claim 17, wherein the second support structure defining two laterally spaced apart guide rails extending along the length of the second support structure for engaging the carriage rollers.

21. The system of claim 20, wherein the second longitudinal support structure comprising an open web constructed base panel structure having portions defining a longitudinal opening extending along the base panel structure for reception of the carriage.

22-27. (canceled)

28. The system of claim 21, wherein:
the base panel structure having side edge portions extending along the base panel structure; and
the second longitudinal support structure further comprising side girders extending along and extending upwardly from the side edge portions of the base panel structure.

29-49. (canceled)

50. The system of claim 17, further comprising:
a housing for enveloping a portion of the conveyor and the apparatus for supporting the work tool and moving the work tool relative to the conveyor, the housing comprising an outlet opening through which the conveyor extends for carrying work products from the working tool; and
a safety guard assembly at the outlet opening, the safety guard comprising a first curtain of suspended pivoting fingers extending across the conveyor and a second curtain of suspended pivoting fingers extending across the conveyor downstream and adjacent the first curtain of suspended pivoting fingers, the first and second curtains of suspended fingers cooperatively pivoting together in a direction downstream of the direction of travel of the conveyor but preventing the second curtain of suspended fingers from pivoting relative to the first curtain of suspended fingers in the direction downstream of the direction of travel of the conveyor.

51-62. (canceled)

63. A system for processing work products, comprising:
a conveyor for advancing the work products;
an apparatus for supporting a work tool and moving the work tool relative to the conveyor, the apparatus comprising:
a first longitudinal support structure;
a second longitudinal support structure comprising a proximal end portion moveable along the first support structure and a distal end portion cantilevered transversely to the length of the first support structure;
a carriage configured to ride along the second support structure on rollers axled to the carriage, the working tool carried by the carriage;
a drive system for moving the second support structure along the first support structure, the drive system also moving the carriage along the second support structure, the drive system comprising a first motive system for moving the second support structure along the first support structure, the first motive system positioned at an elevation above the first support structure, and a second motive system for moving the carriage along the second support structure, the second motive system positioned at an elevation above the first support structure;
a pump system for supplying high pressure fluid for the work tool; and
a control system having circuitry configured to control operation of the pump based on at least one of physical characteristics and parameters of a work product being processed by the work tool.

64. The system of claim 63, wherein the control system is configured for adjusting the operation of the pump system to modulate the pressure of the fluid to the work tool based on at least one of the physical characteristics or parameters of the work product.

65. The system of claim 63, wherein the control system is configured to shift the pump system to a standby status when the work tool is not operating on a work product.

66-67. (canceled)

68. The system of claim 63, further comprising a housing for enveloping a portion of the conveyor and the apparatus for supporting the work tool and moving the work tool relative to the conveyor, the housing defining an accessible compartment for locating the pump.

69-70. (canceled)

71. A method for processing work products, comprising:
advancing work products on a conveyor;
moving a work tool relative to the conveyor;
supplying high pressure fluid with a pump to the work tool; and
controlling, with a computing device, operation of the pump based on at least one of physical characteristics and parameters of a work product being processed by the work tool.

72. The method of claim 71, further comprising adjusting, with a computing device, a pressure of the fluid supplied to the work tool based on at least one of the physical characteristics or parameters of the work product.

73. The method of claim 71, further comprising shifting, with a computing device, the pump to a standby status when the work tool is not operating on a work product.

74. (canceled)

75. The method of claim 74, further comprising adjusting, with a computing device, the operation of the pump to modulate the pressure of the fluid to the work tool based on the generated data related to such physical characteristics or parameters.
